(19) United States
(12) Patent Application Publication
(10) Pub. No.: US 2007/0073689 A1
(43) Pub. Date: Mar. 29, 2007

(54) Automated intelligent discovery engine for classifying computer data files

(76) Inventor: Arunesh Chandra, Boca Raton, FL (US)

Correspondence Address: Gregory P. Gadson, Esq., 19375 Amber Way, Noblesville, IN, 46060, US

(21) Appl. No.: 11/238,687

(22) Filed: Sep. 29, 2005

(51) Int. Cl. G06F 17/30

(52) U.S. Cl. 707/6

(57) ABSTRACT

A novel software engine employs a method of classifying computer data files that at least includes: establishing a plurality of data file classification rules; choosing a weighted factor for each the data file classification rule utilized; scanning at least a portion of a computer system data files; for each data file encountered, applying the data file classification rules according to their weightings; and ranking each data file according to likely relevance to one or more predetermined data file categories.

### BACKGROUND OF THE INVENTION

1. Field of the Invention

The present invention relates to searching for computer files as a precursor to operations such as computer backup, disaster recovery, migration, synchronization, and others.

2. Background

The preservation, restoration, synchronization, and migration of computer data files is of great importance, as data files are often regarded as having great economic value, and not uncommonly great sentimental value as well. New technological improvements and lower memory costs have continued to exponentially increase the number of data files created and maintained by present-day computer systems. Along with traditional text and graphic information, many files also contain multimedia content such as pictures, audio (including music), and video, all in various formats now available. It is now common for many desktop computer systems to contain more than forty thousand data files.

Software tools are now commercially available to aid non information technology professionals in operations such as backup, disaster recovery, migration of files—including data files—for restoration on the same computer, or migration to a new (target) computer. Brute force approaches exist for backing up, recovering, or migrating all files of a system. However, such brute force approaches are time-consuming, resource-intensive, and often save or duplicate files that are not actually necessary for recreation of a computer system's user state. For example, users may wish to distinguish between user-created data files, and system data files. Lost or corrupted system data files are often readily recoverable by reinstalling the system, whereas user-created data files are not recoverable in the same manner.

What is then of importance is an approach for gathering for consideration, all files of importance to a computer user than cannot be recovered or duplicated by reinstalling system software. Improvements over brute force approaches have been developed which use the following criteria for determining whether a data file is of importance for operations such as backup, synchronization, disaster recover, and migration: file name; file location; file content pattern; file creation, modification and access dates; file type; and file size; etc.

While the latter approach is an improvement over brute force methods, it still does not sufficiently eliminate data files that are not really of long-term importance to the user. Further, there is no flexibility that will allow a user to cause the consideration of data files to be tailored to the user's particulars. And, there is no ability of such tools to gain intelligence as the data file consideration process completes iterations.

What is therefore desirable but not taught nor suggested by the prior art, is a software tool for intelligently considering data files, allowing a user to establish and weight rules that the software tool uses for categorizing data files into system files or user-created files of importance.

### SUMMARY OF THE INVENTION

In view of the aforementioned problems and deficiencies of the prior art, the present invention provides a method of classifying computer data files at least including: establishing a plurality of data file classification rules; choosing a weighted factor for each the data file classification rule utilized; scanning at least a portion of a computer system data files; for each data file encountered, applying the data file classification rules according to their weightings; and ranking each data file according to likely relevance to one or more predetermined data file categories.

The present invention also provides a software engine adapted to automatically classify computer data files, the engine at least including: a data file classification rule establisher adapted to establish a plurality of data file classification rules; a data file classification rule weighter adapted to weight each the data file classification rule utilized; a data file scanner adapted to scan at least a portion of a computer system data files; a data file rule applier adapted to apply the data file classification rules according to their weightings to each data file encountered; and a data file ranker adapted to rank each data file according to likely relevance to one or more predetermined data file categories.

### BRIEF DESCRIPTION OF THE DRAWING FIGURES

Features and advantages of the present invention will become apparent to those skilled in the art from the description below, with reference to the following drawing figures, in which:

FIG. 1 is a schematic diagram of the present-inventive system for classifying computer data files;

FIG. 2 is schematic diagram of the automated intelligent discovery engine portion of the system of FIG. 1; and

FIG. 3 is a flowchart detailing the present-inventive method for classifying computer data files.

### DESCRIPTION OF THE PREFERRED EMBODIMENTS

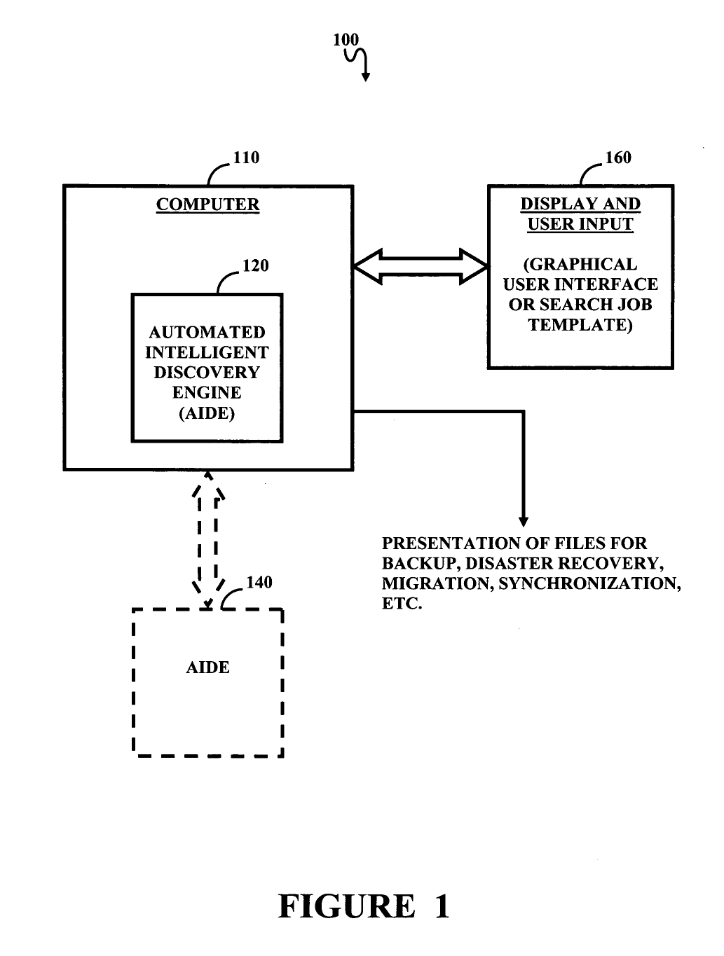

A schematic diagram of the present-inventive system 100 for the intelligent classification of computer data files is shown in FIG. 1. The computer 110 shown, while typically of a desktop or notebook variety, need not be so limited. Different computer system sizes and types, as well as other electronic devices and systems may also be used in the present-inventive data file classification scheme. An automated intelligent discovery engine (AIDE) 120 is at the heart of the system 100. The AIDE 120 is a software tool that can be installed on the computer 110. Alternatively, the AIDE can reside external to the computer 110, as shown by the option labeled 140.

The results and updates of the file classification process are displayed on a display included in the numbered element 160 for convenience. The element 160 also includes a keyboard or other input device as is common in computer systems. The user communicates with the AIDE 120 via a graphical user interface (GUI) or a search job template.

At the end of the classification of all data files, the appropriate user-created data files can be presented for further use as part of processes such as backup, disaster recovery, migration, synchronization, etc.

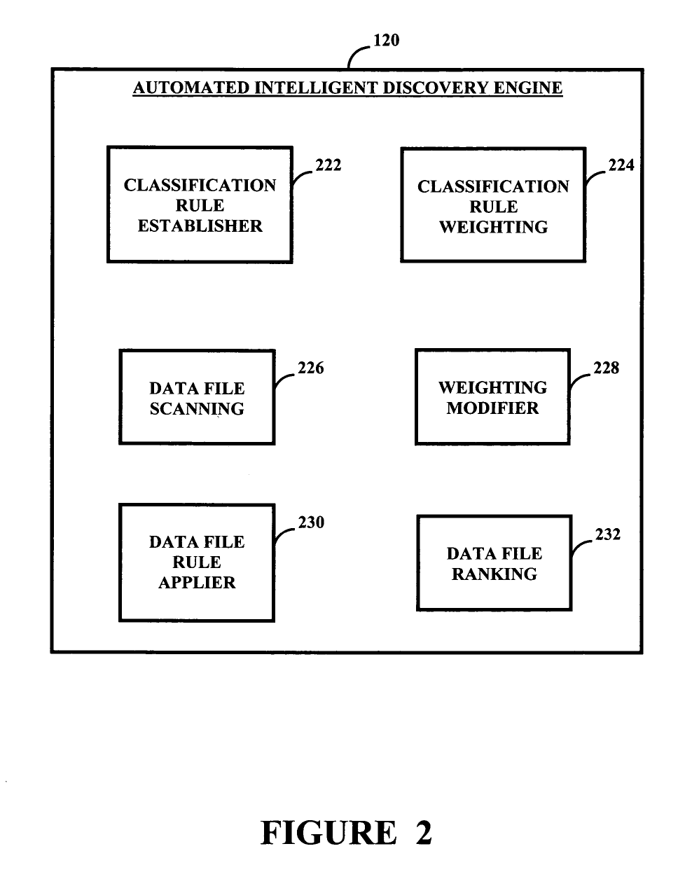

The main modules of the AIDE 120 are shown in FIG. 2. A data file classification rule establisher 222 allows the user to choose the classification rules that will be used to classify each data file encountered. A data classification weighting module 224 allows the user to choose the weighting for each rule used in the classification process. The AIDE 120 scans the contents of the computer system 110 to consider each data file symbolically via a data file scanning module 226. Also, a weighting modifier 228 can automatically modify the weightings of the classification rules based on the detected usage of the data files. The AIDE 120 further applies the weighted data file classification rules (symbolically via a data file rule applier 230), followed by a ranking of the encountered data files (symbolically via a data file ranking module 232).

In the preferred embodiment, all ranked data files are presented to the user with a ranking, allowing the user to make the final decision as to which data files are important, and therefore appropriate for further processing (e.g., backup, migration, etc.), or which files are either system files, or should nonetheless be ignored. In an alternate embodiment, the AIDE 120 can automatically place the data files that it determines are appropriate for further processing in one group, and place all other files in a secondary group not recommended for further processing.

In addition to the criteria (i.e., file name, file location, content patter, file dates, file type, and file size) mentioned in the “Background” section above, the AIDE utilizes rules which the user can weight to his or her liking. The weighted rules include: whether a data file is a more recently used one (with “recent” being definable); whether a data file matches a recent search patter (again with “recent” being definable), whether a data file name includes the name of a user (with the user identity or identities being definable), and whether a data file name includes a definable keyword. If the option to allow the AIDE 120 to automatically classify the data files is chosen, the user may also choose the appropriate rank index threshold number. Those skilled in the art to which the present invention pertains will appreciate that the AIDE can use scripts to carry out the classification operation and automatically select the appropriate data files for further use (e.g., backup, migration, synchronization, etc.).

The data can take on many forms, including the keys and values that are used for system settings.

Below is a practical example of weighted rules that a user might choose for the AIDE. In the example, the user has decided that: files smaller than 1 megabyte will receive −600 (negative 600) points; file extensions (which designate file type) with “jpg” will receive 100 points; file locations with “% windir %” will receive −500 (negative 500) points; file locations with “% mydocs %” will receive 500 points; file extensions with “pdf” will receive 250 points; and file locations with “% Desktop %” will also receive 250 points. Each file encountered during scanning can therefore be ranked by combining the points listed above as relates to the particular file.

The example shows that the user in this case is uninterested in small files, unless other criteria are met. The example also shows that the user is greatly interested in files that that are in the “% mydocs %” location (which files are generally user-created data files), while generally having little interest in files that are in the “% windir %” location (which files are likely to be system data files). The user also has a moderate interest in “pdf” files and files located on the desktop.

The user can designate the threshold value for deciding whether a file should be further processed (i.e., backup, migration, synchronization, etc.), or simply allow the AIDE to choose the threshold value (which may be a default value). For example, data files having a rank at least equal to 0 can be classified as important for further processing. Those skilled in the art will appreciate that other threshold values (greater than 0 or less than 0) can be chosen.

Returning to the practical example, assume that the following three files stored on a Microsoft Windows based PC have been encountered by the AIDE (with the file size also listed).

1) C:\Windows\1.JPG; size: 3 MB

2) C:\Documents & Settings\<username>\My Documents\2.JPG; size: 0 KB

3) C:\Documents & Settings\<username>\My Documents\3.JPG; size: 5 MB

The results of the AIDE data file ranking are:

| File Name | Size | Rank |
|---|---|---|
| 3) C:\Documents & Settings\<username> | 5 MB | 600 |
| \My Documents\3.JPG | | |
| 2) C:\Documents & Settings\<username> | 0 MB | 0 |
| \My Documents\2.JPG | | |
| 1) C:\Windows\1.JPG; size: 3 MB | 3 MB | −400 |

The file 1) receives −500 points for being located in the windows directory, and 100 points for being a “jpg” file, for a total of −400, indicating that it should not be considered for further processing. On the other hand, file 3) receives 500 points for being in the “% mydocs %” directory, and 100 points for being a “jpg” file, for a total of 600, indicating that it should definitely be considered for further processing. The file 2) receives 500 points for being in the “% mydocs %” directory, 100 points for being a “jpg” file, and −600 points for being smaller than 1 megabyte, for a total of 0, indicating perhaps ambivalence about whether it should be further processed. The decision on whether to further process file 2) automatically, will of course depend on the threshold value chosen.

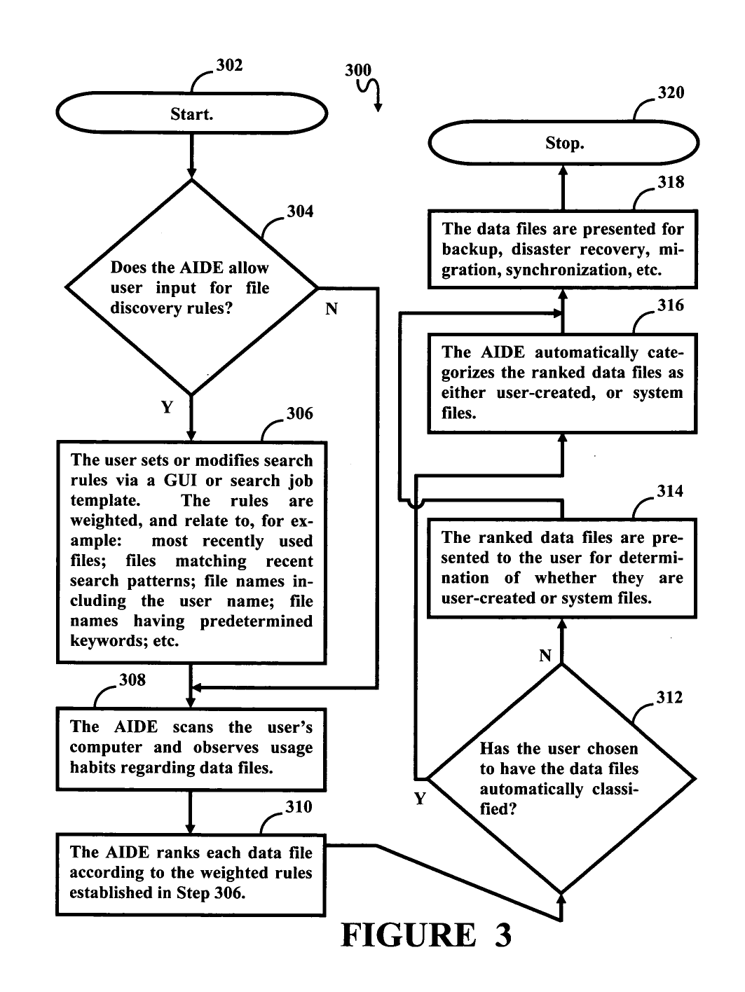

The flowchart in FIG. 3 summarizes the general algorithm 300 used by the AIDE to classify computer data files. After the start (Step 302), the algorithm determines whether the AIDE allows the user to determine which classification rules to use (Step 304). The latter step does not affect the user's ability to input specific information such as user name, keywords, etc. If the AIDE does not allow changing of the classification rules (not the preferred embodiment), the algorithm jumps to Step 308.

In the normal course, the algorithm proceeds from Step 304 to Step 306, where the user sets or modifies the data file classification rules, and sets the desired weight for each. In Step 308, the AIDE scans the user's computer data files and observes the usage habits regarding each data file. Next, the AIDE ranks each data file according to the weighted classification rules (Step 310).

Several rules are applied when ranking files. These rules are based on common attributes of files such as filename, date created, date modified, date accessed, file extension, and file location. Each of these rules ranks files based on the matching criteria of the rule. For instance, if a file is modified within five days, it would be ranked higher than files that were modified ten days or more previously. Similarly, if a file is located in the “Windows” folder it would receive a lower rank than those located in the “My Documents” folder. Many of these rules are based from the common standard Windows specification, such as common file types, file association with common application, known file extensions, etc.

In Step 312, the algorithm determines whether the user has chosen to have the data files automatically classified (for example, as an important user-created data file, as opposed to others such as system data files), or whether the user will make the final decision for data files, based on the rankings. If the user will have the last word, the files are present to the user for a final determination (Step 314). Otherwise, the AIDE automatically categorizes the data files as user-created (and available for further processing), or system files (not to be further processed) in Step 316.

The data files which are designated for further processing are presented to the appropriate tool for further processing according to the operation involved (e.g., backup, synchronization, migration, disaster recovery, etc.) in Step 318. The algorithm stops in Step 320.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A method of classifying computer data files comprising:
establishing a plurality of data file classification rules;
choosing a weighted factor for each said data file classification rule utilized;
scanning at least a portion of a computer system data files;
for each data file encountered, applying said data file classification rules according to their weightings; and
ranking each data file according to likely relevance to one or more predetermined data file categories.

2. The method of claim 1, wherein said predetermined data file categories comprise user-created data files, and system data files.

3. The method of claim 1, further comprising:
automatically modifying the weighting or the data file classification rules based on perceived user computer system usage.

4. The method of claim 1, wherein said data file classification rules comprise:
considering recent usage of a data file.

5. The method of claim 1, wherein said data file classification rules further comprise:
considering whether a data file matches a recent file search pattern.

6. The method of claim 1, wherein said data file classification rules further comprise:
considering whether a data file name includes at least a portion of a user's name.

7. The method of claim 1, wherein said data file classification rules further comprise:
considering whether a data file name includes at least one or more predetermined keywords.

8. The method of claim 1, wherein said data file classification rules are modifiable by a user.

9. The method of claim 8, further comprising:
allowing a user to modify said data file classification rules via a graphical user interface.

10. The method of claim 8, further comprising:
allowing a user to modify said data file classification rules via a search job template.

11. A software engine adapted to automatically classify computer data files, said engine comprising:
a data file classification rule establisher adapted to establish a plurality of data file classification rules;
a data file classification rule weighter adapted to weight each said data file classification rule utilized;
a data file scanner adapted to scan at least a portion of a computer system data files;
a data file classification rule applier adapted to apply said data file classification rules according to their weightings to each data file encountered; and
a data file ranker adapted to rank each data file according to likely relevance to one or more predetermined data file categories.

12. The engine of claim 11, wherein said predetermined data file categories comprise user-created data files, and system data files.

13. The engine of claim 11, further comprising:
a data file classification rule weighting modifier adapted to automatically modifying the weighting or the data file classification rules based on perceived user computer system usage.

14. The engine of claim 11, wherein said data file classification rules comprise:
considering recent usage of a data file.

15. The engine of claim 11, wherein said data file classification rules further comprise:
considering whether a data file matches a recent file search pattern.

16. The engine of claim 11, wherein said data file classification rules further comprise:
considering whether a data file name includes at least a portion of a user's name.

17. The engine of claim 1, wherein said data file classification rules further comprise:
considering whether a data file name includes at least one or more predetermined keywords.

18. The engine of claim 11, wherein said data file classification rule establisher is further adapted to allow said data file classification rules to be modified by a user.

19. The engine of claim 18, wherein said data file classification rules are modifiable via a graphical user interface.

20. The engine of claim 18, wherein said data file classification rules are modifiable via a search job template.
